(19) United States
(12) Patent Application Publication
(10) Pub. No.: US 2025/0253369 A1
(43) Pub. Date: Aug. 7, 2025

(54) ANODE SUB-SYSTEM LAYOUT FOR SINGLE VALVE FREEZE PURGE CAPABILITY

(71) Applicant: GM Global Technology Operations LLC, Detroit, MI (US)

(72) Inventor: Joseph Hahn, White Lake Charter Township, MI (US)

(73) Assignee: GM Global Technology Operations LLC, Detroit, MI (US)

(21) Appl. No.: 18/431,037

(22) Filed: Feb. 2, 2024

(51) Int. Cl. H01M 8/04746; B60L 50/72; B60L 58/30; H01M 8/04119; H01M 8/04223; H01M 8/04225; H01M 8/04302

(52) U.S. Cl. CPC H01M 8/04746; B60L 50/72; B60L 58/30; H01M 8/04164; H01M 8/04225; H01M 8/04231; H01M 8/04253; H01M 8/04268; H01M 8/04302; H01M 2250/20

(57) ABSTRACT

A capture device including a body defining a chamber configured to receive liquid and gas from a fuel cell system. The chamber includes an upper end region and a lower end region. An outlet is disposed at the body in fluid communication with the lower end region of the chamber. A gas bypass hose includes a first end in fluid communication with the upper end region of the chamber and a second end in fluid communication with the lower end region of the chamber. A solenoid valve is disposed between the chamber and the outlet. The solenoid valve is operable between an open state permitting fluid communication between the chamber and the outlet to drain liquid and purge gas from the chamber and a closed state preventing fluid communication between the chamber and the outlet.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a hydrogen fuel cell system that includes an anode subsystem that facilitates a closed loop water separation and gas recirculation procedure for the fuel cell system. The anode subsystem captures water and hydrogen gas from a fuel cell outlet, separates the water from the gas to exhaust the water from the fuel cell system, and the anode subsystem may purge the separated gas or recirculate the gas back into the fuel cell system as needed.

Typically, an anode subsystem contains one valve for draining liquid from the system, and one valve for purging gas, for a total of two valves. To satisfy packaging constraints, reduce weight, and improve control simplicity, it is desirable for the anode subsystem to contain only one valve capable of performing both the liquid draining and the gas purging functions. However, when the fuel cell is required to initiate operations in freezing temperatures, a single valve positioned to adequately drain water from the anode subsystem may be unable to purge gas due to residual frozen water blocking the passageway through the single valve. While a heater may be incorporated into the design of the anode subsystem to melt the frozen water, this process may take several minutes. It is desirable to be able to purge gas and facilitate proper operation of the fuel cell system within seconds of vehicle startup.

### SUMMARY

One aspect of the disclosure provides a capture device. The capture device includes a body defining a chamber configured to receive liquid and gas from a fuel cell system. The chamber includes an upper end region and a lower end region. The capture device includes an outlet disposed at the body and in fluid communication with the lower end region of the chamber. A gas bypass hose includes a first end at the body and in fluid communication with the upper end region of the chamber and a second end at the body and in fluid communication with the lower end region of the chamber. A solenoid valve is disposed between the chamber and the outlet. The solenoid valve is operable between an open state permitting fluid communication between the chamber and the outlet to drain liquid and purge gas from the chamber and a closed state preventing fluid communication between the chamber and the outlet.

Implementations of the disclosure may include one or more of the following optional features. In some examples, the capture device further includes a sump at the lower end region of the chamber. The outlet and the second end of the gas bypass hose are fluidly connected to the sump at respective positions above a maximum liquid line. In further examples, the maximum liquid line is based on a volume of liquid collected at the sump when the fuel cell system is not being operated. In other further examples, the capture device further includes a valve conduit extending between the chamber and the outlet. The outlet and the second end of the gas bypass hose are fluidly connected to the valve conduit at respective positions above the maximum liquid line to permit fluid communication between the gas bypass hose and the outlet when the solenoid valve is in the open state.

In some implementations, the capture device further includes a heater disposed at the outlet.

In some aspects, the gas bypass hose maintains fluid communication between the upper end region of the chamber and the lower end region of the chamber.

In some examples, the solenoid valve is operated in the open state and the closed state based on a control signal from a control module of an application equipped with the capture device. In further examples, the solenoid valve is operated in the open state responsive to the control signal instructing the capture device to drain liquid from the chamber, and the control signal instructing the capture device to purge gas from the chamber. In other further examples, the solenoid valve is operated in the open state responsive to the control signal indicating startup of the application.

In some implementations, the upper end region of the chamber is oriented above the lower end region of the chamber.

Another aspect of the disclosure provides a fuel cell system. The fuel cell system includes a capture device. The capture device includes a body defining a chamber configured to receive liquid and gas from the fuel cell system. The chamber includes an upper end region and a lower end region. An outlet is disposed at the body and in fluid communication with the lower end region of the chamber. A gas bypass hose includes a first end at the body and in fluid communication with the upper end region of the chamber and a second end at the body and in fluid communication with the lower end region of the chamber. A solenoid valve is disposed between the chamber and the outlet. The solenoid valve is operable between an open state permitting fluid communication between the chamber and the outlet to drain liquid and purge gas from the chamber and a closed state preventing fluid communication between the chamber and the outlet.

Implementations of this aspect of the disclosure may include one or more of the following optional features. In some examples, the capture device further includes a sump at the lower end region of the chamber. The outlet and the second end of the gas bypass hose are fluidly connected to the sump at respective positions above a maximum liquid line. The maximum liquid line is based on a volume of liquid collected at the sump when the fuel cell system is not being operated. In further examples, the capture device further includes a valve conduit extending between the chamber and the outlet. The outlet and the second end of the gas bypass hose are fluidly connected to the valve conduit at respective positions above the maximum liquid line to permit fluid communication between the gas bypass hose and the outlet when the solenoid valve is in the open state. In other further examples, the gas bypass hose maintains fluid communication between the upper end region of the chamber and the lower end region of the chamber. In other further examples, the solenoid valve is operated in the open state and the closed state based on a control signal from a control module of an application equipped with the capture device. The solenoid valve is operated in the open state responsive to the control signal instructing the capture device to drain liquid from the chamber, the control signal instructing the capture device to purge gas from the chamber, and the control signal indicating startup of the application.

Yet another aspect of the disclosure provides a vehicle. The vehicle includes a fuel cell system. The fuel cell system includes a capture device. The capture device includes a body defining a chamber configured to receive liquid and gas from the fuel cell system. The chamber includes an upper end region and a lower end region. An outlet is disposed at the body and in fluid communication with the lower end region of the chamber. A gas bypass hose includes a first end at the body and in fluid communication with the upper end region of the chamber and a second end at the body and in fluid communication with the lower end region of the chamber. A solenoid valve is disposed between the chamber and the outlet. The solenoid valve is operable between an open state permitting fluid communication between the chamber and the outlet to drain liquid and purge gas from the chamber and a closed state preventing fluid communication between the chamber and the outlet.

Implementations of this aspect of the disclosure may include one or more of the following optional features. In some examples, the capture device further includes a sump at the lower end region of the chamber. The outlet and the second end of the gas bypass hose are fluidly connected to the sump at respective positions above a maximum liquid line. The maximum liquid line is based on a volume of liquid collected at the sump when the fuel cell system is not being operated.

In some implementations, the capture device further includes a valve conduit extending between the chamber and the outlet. The outlet and the second end of the gas bypass hose are fluidly connected to the valve conduit at respective positions above the maximum liquid line to permit fluid communication between the gas bypass hose and the outlet when the solenoid valve is in the open state.

In some aspects, the gas bypass hose maintains fluid communication between the upper end region of the chamber and the lower end region of the chamber.

In some examples, the solenoid valve is operated in the open state and the closed state based on a control signal from a control module of an application equipped with the capture device. The solenoid valve is operated in the open state responsive to the control signal instructing the capture device to drain liquid from the chamber, the control signal instructing the capture device to purge gas from the chamber, and the control signal indicating startup of the application.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a side view of a vehicle equipped with a fuel cell system.

FIGS. 2 and 3 are perspective views of a single-valve anode subsystem of the fuel cell system.

FIG. 4 is a sectional view of the anode subsystem taken along line 4-4 in FIG. 2.

FIG. 4A is an enlarged view of area 4A in FIG. 4.

FIG. 5 is a sectional view of the anode subsystem taken along line 5-5 in FIG. 2.

FIG. 5A is an enlarged view of area 5A in FIG. 5.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

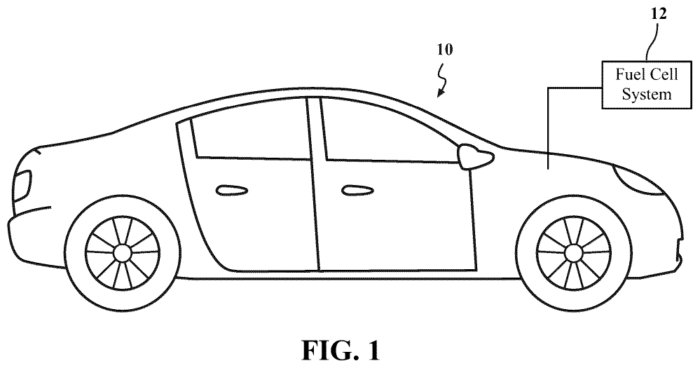

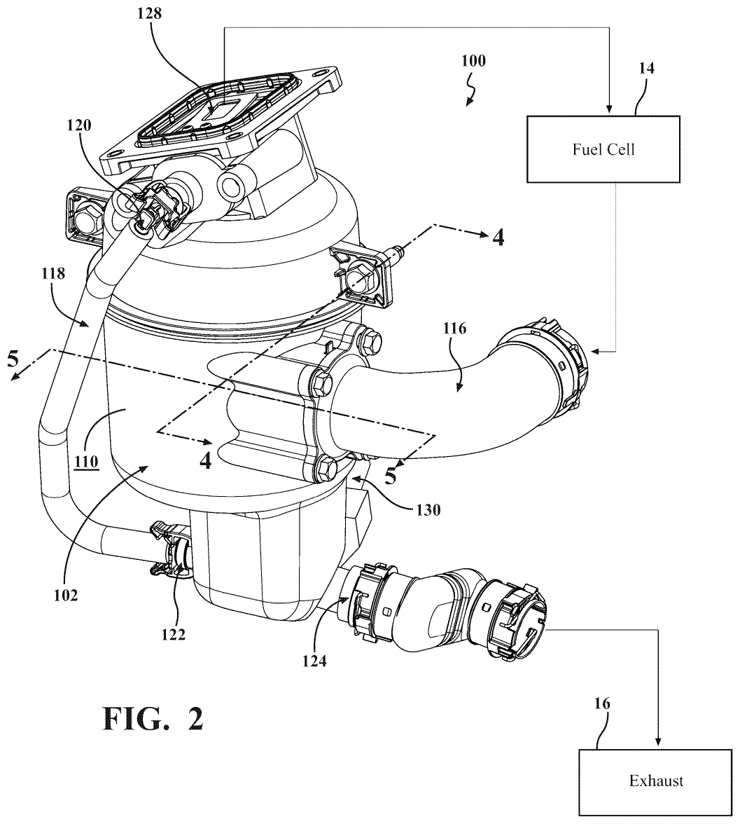

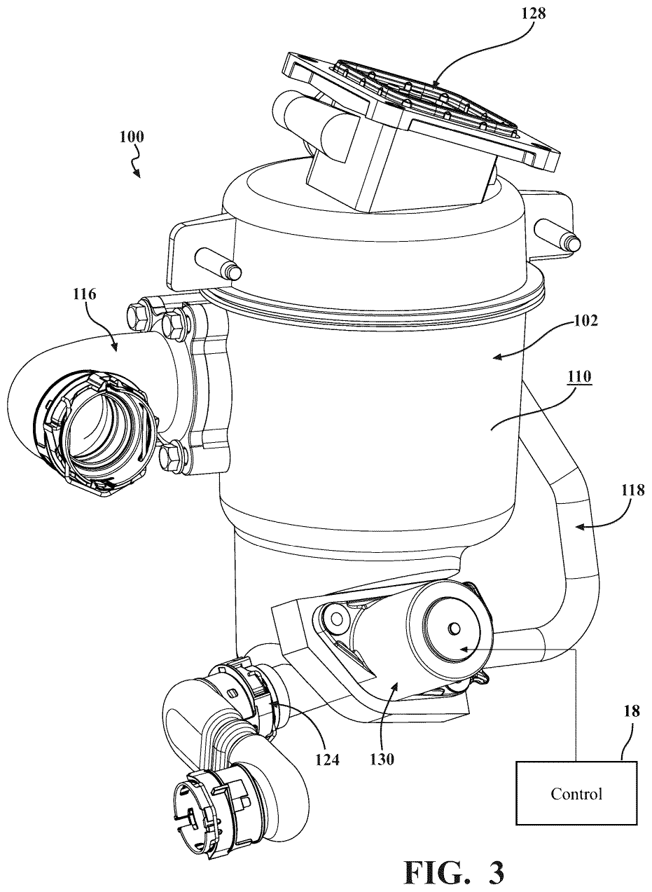

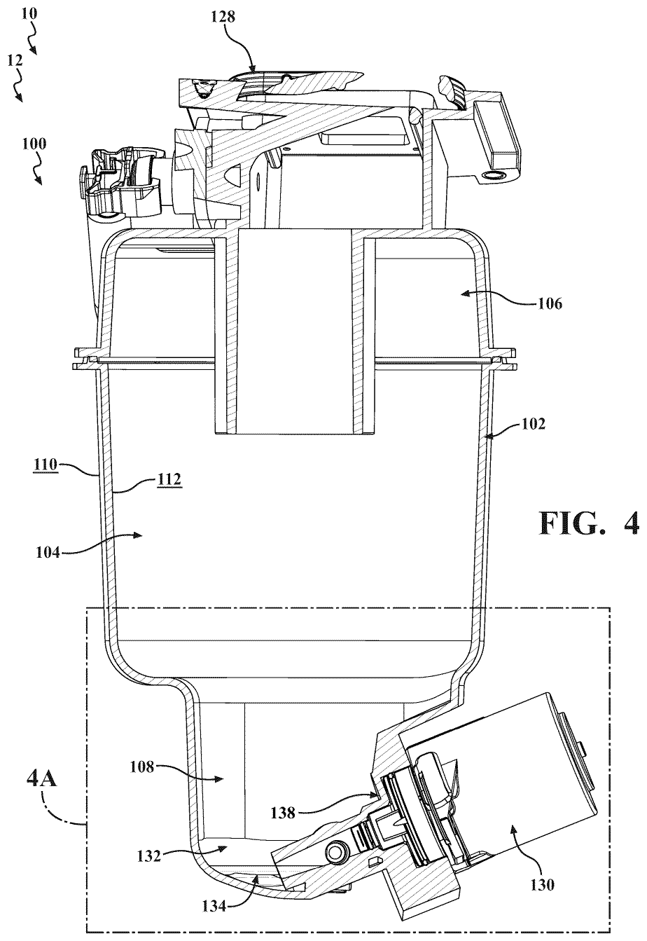

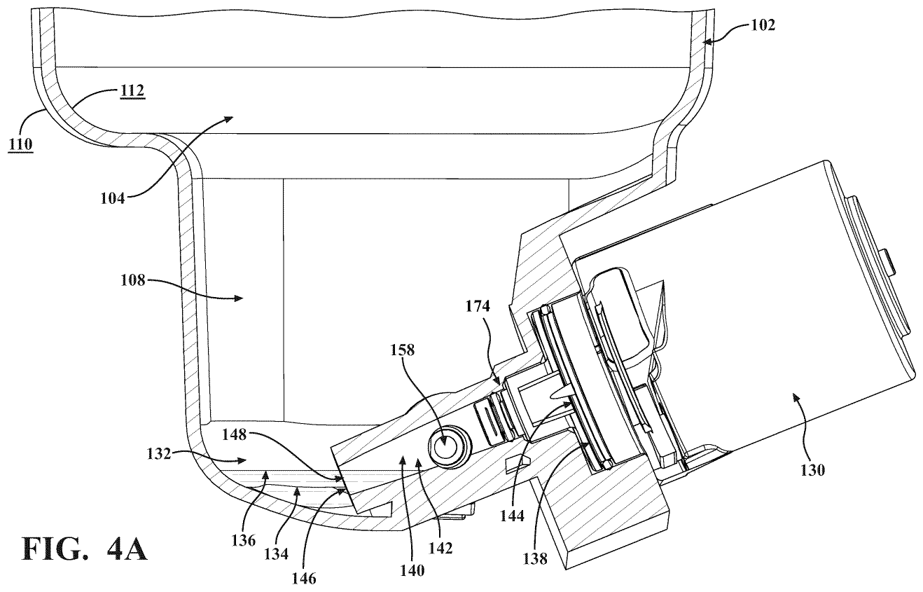

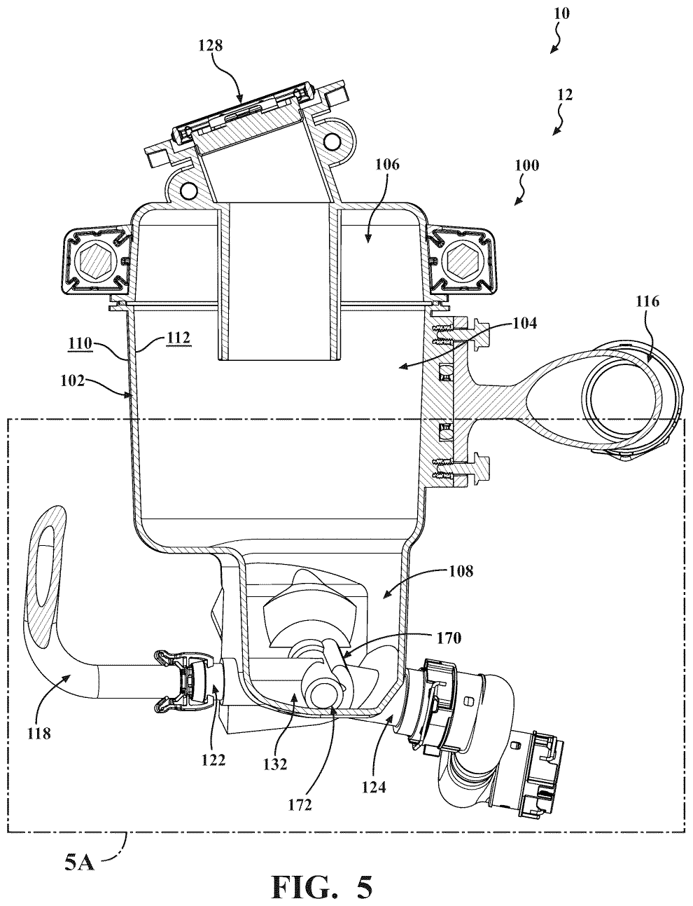

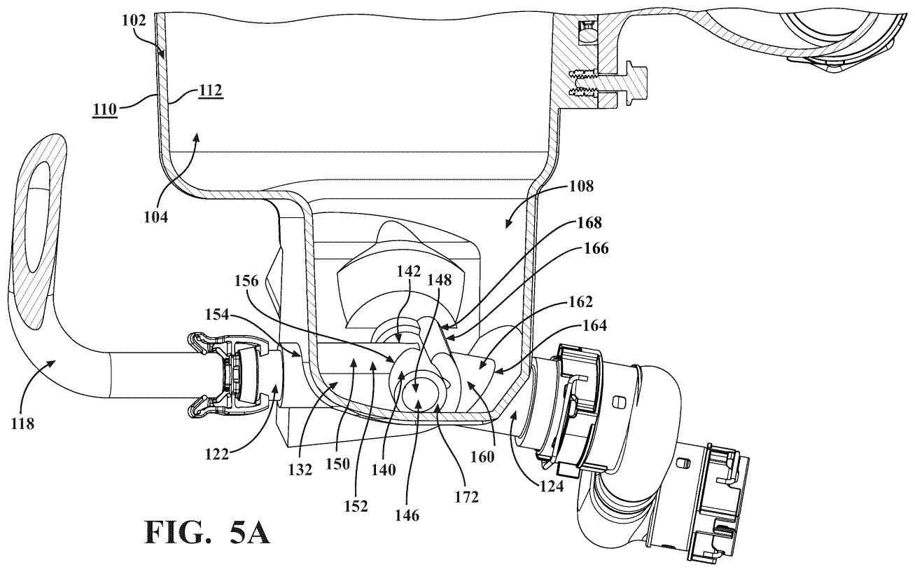

With reference to FIGS. 1-3, an application, such as a vehicle 10, is powered by a hydrogen fuel cell system 12 that includes a fuel cell 14 and a capture device or an anode subsystem 100. The capture device 100 includes a body 102 defining a cavity or chamber 104 (FIG. 4) and having an upper end region 106 and a lower end region 108 opposite the upper end region 106. The upper end region 106 and the lower end region 108 of the chamber 104 are in fluidic communication with one another. With the capture device 100 mounted at the vehicle 10, the upper end region 106 is oriented above the lower end region 108 such that liquid water may flow within the chamber 104 toward the lower end region 108 and gas may flow unaided within the chamber 104 toward the upper end region 106. Furthermore, and as shown in FIG. 4, the body 102 includes an exterior surface 110 and an interior surface 112 opposite the exterior surface 110, the interior surface 112 defining the chamber 104.

The body 102 may be formed from one or more varieties of rigid material, such as steel, aluminum, plastic, or any other suitable material, and is capable of containing a liquid and gas mixture within the chamber 104. That is, the chamber 104 is configured to receive liquid and gas from the hydrogen fuel cell system 12. For example, an intake hose 116 extends from the body 102 and provides a passageway between an outlet of the fuel cell 14 and the capture device 100. During operation of the hydrogen fuel cell system 12, liquid water and gas is expelled from the fuel cell 14 into the chamber 104 of the capture device 100 through the intake hose 116.

Furthermore, the capture device 100 includes a gas bypass hose 118 that includes a first end 120 and a second end 122 opposite the first end 120. The first end 120 is disposed at the body 102 and is in fluid communication with the upper end region 106 of the chamber 104, and the second end 122 is disposed at the body 102 and is in fluid communication with the lower end region 108 of the chamber 104. The first end 120 and the second end 122 are in fluid communication with one another to provide fluid communication between the chamber 104 at the upper end region 106 and the lower end region 108.

A first outlet or exhaust outlet 124 is disposed at the body 102 and is in fluid communication with the lower end region 108 of the chamber 104. The outlet 124 provides a fluid passageway away from the capture device 100, such as to an exhaust system 16 of the vehicle 10 or a water recapture device (not shown) to allow liquid water and/or gas to be removed from the hydrogen fuel cell system 12 as waste products.

An electrically operable solenoid valve 130 is disposed between the chamber 104 and the outlet 124 for controlling the flow of liquid and/or gas from the chamber 104 to the exhaust 16. That is, the solenoid valve 130 may be electrically operable to adjust between an open state, where the solenoid valve 130 allows fluid communication between the chamber 104 and the outlet 124 to drain liquid and/or purge gas from the chamber 104, and a closed state, where the solenoid valve 130 does not allow fluid communication between the chamber 104 and the outlet 124 and liquid and gas are retained in the chamber 104. The exhaust 16 may provide a lower pressure region compared to the chamber 104 (e.g., the exhaust 16 may be at atmospheric pressure and the chamber 104 may have an elevated pressure greater than atmospheric pressure), such that the liquid and/or gas are urged through the outlet 124 toward the exhaust 16 when the solenoid valve 130 is operated in the open state. The solenoid valve 130 may include any variety of valve that is electronically operable and capable of preventing the flow of water and gas through the outlet 124 and facilitating the flow of water and gas through the outlet 124. Adjustment of the solenoid valve 130 between the closed state and the open state may be controlled via electronic communication between the solenoid valve 130 and an electronic control module 18 of the hydrogen fuel cell system 12 and/or vehicle 10.

A second outlet or gas recirculation outlet 128 is disposed at the body 102 and in fluid communication with the upper end region 106 to provide a passageway for gas to recirculate back into the fuel cell 14. The outlet 128 includes a check valve to control the amount of gas that recirculates into the fuel cell 14. Gas remaining within the chamber 104 may be purged from the hydrogen fuel cell system 12 via operation of the solenoid valve 130.

In the illustrated example, the lower end region 108 of the chamber 104 includes a sump 132 in open fluidic communication with the rest of the chamber 104 (FIG. 4). The sump 132 may provide a collection area for liquid water within the chamber 104. The second end 122 of the gas bypass hose 118 and the outlet 124 may be in fluid communication with the sump 132. Accordingly, water captured by the capture device 100 may flow within the chamber 104 toward the sump 132 at the lower end region 108 of the chamber 104. Operation of the solenoid valve 130 to the open state may clear liquid water and/or gas from the sump 132 through the outlet 124.

As shown in FIGS. 4 and 4A, an amount of residual water 134 is collected within the sump 132, where the amount of the residual water 134 corresponds to a maximum liquid or water line or volume 136. The maximum water line 136 represents the height of the residual water 134 at the sump 132 when the hydrogen fuel cell system 12 is not being operated and/or when the residual water 134 freezes and expands. In other words, when the hydrogen fuel cell system 12 is not in a state of operation, and the residual water 134 collects within the sump 132, such as due to condensation of gas, the residual water 134 and/or frozen residual water 134 may not be above the maximum water line 136. The maximum water line 136 may be determined based on a volume of residual water 134 expected to collect within the sump 132, such as based on a volume of the chamber 104 (and, thus, a volume of gas expected to condense within the chamber 104 when the hydrogen fuel cell system 12 is not being operated) and expansion of the amount of residual water 134 upon freezing. An opening of the second end 122 of the gas bypass hose 118 and/or an opening of the outlet 124 are connected to the sump 132 and in fluid communication with the sump 132 at respective positions located above the maximum water line 136 to prevent frozen residual water 134 from blocking these openings.

Referring to FIGS. 4, 4A. 5, and 5A, the solenoid valve 130 includes a valve base 138 disposed at the exterior surface 110 of the body 102 of the capture device 100. A valve duct or conduit 140 extends from the valve base 138 and at least partially within the chamber 104 at the sump 132. For example, the valve conduit 140 may extend from and be integrally formed with the interior surface 112 of the body 102 of the capture device 100. The valve conduit 140 defines a valve conduit channel or passageway 142 extending between a first end or valve end 144 and a second end or sump end 146 of the valve conduit 140. The valve end 144 is disposed at the valve base 138 and the sump end 146 is positioned within the chamber 104 at the sump 132. In the illustrated example, an opening 148 of the valve conduit channel 142 at the sump end 146 is disposed at least partially below the maximum water line 136 and, thus, fluid communication between the chamber 104 and the valve conduit channel 142 may be at least partially blocked when residual water 134 collects and freezes in the sump 132.

A gas duct or conduit 150 extends between and fluidly connects the second end 122 of the gas bypass hose 118 with the valve conduit 140 and, thus, the chamber 104 at the sump 132. For example, the gas conduit 150 may extend from and be integrally formed with the interior surface 112 of the body 102 of the capture device 100. The gas conduit 150 defines a gas conduit channel or passageway 152 extending between a first end or gas conduit end 154 at the second end 122 of the gas bypass hose 118 and a second end or valve conduit end 156 in fluid communication with the valve conduit channel 142. A gas opening 158 at the valve conduit end 156 of the gas conduit 150 allows gas to flow from the gas bypass hose 118 and into the valve conduit 140. The gas opening 158 may be positioned at least partially above the maximum water line 136 to allow the flow of gas between the chamber 104 and the valve conduit 140 even when the sump end 146 of the valve conduit 140 is blocked.

Furthermore, a drainage conduit or duct 160) extends between the solenoid valve 130 and the outlet 124 to allow for fluid communication between the chamber 104, the gas bypass hose 118, and the outlet 124 when the solenoid valve 130 is in the open state. For example, the drainage conduit 160 extends from and is integrally formed with the interior surface 112 of the body 102. The drainage conduit 160 defines a drainage channel or passageway 162 extending between a first end or outlet end 164, and a second end 166. The first end 164 is in fluid communication with the outlet 124 and the second end 166 includes a drainage opening 168 in fluid communication with the solenoid valve 130. For example, the drainage opening 168 may be formed at the solenoid base 138. Because the drainage opening 168 is formed at the solenoid base 138, the drainage opening 168 is above the maximum water line 136 and, thus, allows for fluid to flow to the outlet 124 even in freezing conditions. When in the open state, the solenoid valve 130 provides fluid communication between the drainage opening 168 and the valve conduit 140. A bypass channel or portion 170 of the drainage conduit 160 extends from the second end 166 of the drainage conduit 160 at the solenoid base 138 and at least partially along the valve conduit 140 toward the first end 164 of the drainage conduit 160 at the outlet 124.

When the solenoid valve 130 is in the open state, fluid communication is allowed between the chamber 104, the gas bypass hose 118, and the outlet 124 via the gas conduit 150, the valve conduit 140, the solenoid valve 130, and the drainage conduit 160. That is, with the solenoid valve 130 in the open position, the gas opening 158 and the drainage opening 168 remain open and unobstructed, allowing for the flow of liquid and/or gas through the gas opening 158 and the drainage opening 168 toward the outlet 124. With the solenoid valve 130 in the closed state, fluid communication is blocked between the chamber 104 (including the gas bypass hose 118) and the outlet 124. For example, the solenoid valve 130 includes a plunger 174 that engages the solenoid base 138 in the closed state and that is retracted from the solenoid base 138 in the open state. As shown in FIG. 4A, when the solenoid valve 130 is in the closed state, the plunger 174 engages the solenoid base 138 at the first end 144 of the valve conduit 140 to close over the first end 144 of the valve conduit 140 and the drainage opening 168 at the solenoid base 138 to block fluid flow from the valve conduit 140) and the gas conduit 150 toward the drainage opening 168. When the solenoid valve 130 is moved to the open state, the plunger 174 is retracted from the solenoid base 130 to allow fluid flow through the first end 144 of the valve conduit 140 and toward the drainage opening 168, thus fluidly connecting the valve conduit 140 and the gas conduit 150 to the drainage conduit 160 through the solenoid base 138 and the bypass channel 170.

In operation, the capture device 100 separates water and gas that enters the capture device 100 from the fuel cell 14 via the intake hose 116. The fuel cell 14 may require a specific amount of hydrogen or fuel to be present in the hydrogen fuel cell system 12 in order for the fuel cell 14 to function properly and efficiently. The specific amount of required hydrogen or fuel may be constantly changing based on the operational condition of the fuel cell 14 and the vehicle 10. To supplement the amount of hydrogen or fuel in the hydrogen fuel cell system 12, the capture device 100 recirculates gas to the hydrogen fuel cell system 12 via the check valve 128. Meanwhile, liquid is drained and excess gas may be purged from the system 100 at the solenoid valve 130.

When the hydrogen fuel cell system 12 is not being operated, residual water 134 may collect in the sump 132, such as due to condensation of water within the capture device 100. When the ambient temperature at the capture device 100 is above the freezing temperature of water, the residual water 134 may be in liquid form. When the vehicle 10 is started and operation of the hydrogen fuel cell system 12 begins (i.e., operation of the propulsion system of the vehicle 10 is initiated), gas may be purged and liquid water may be drained from the capture device 100. The solenoid valve 130 provides the dual function of draining liquid water and purging gas from the capture device 100 by adjusting between the closed state and the open state. Because the residual water 134 is in liquid form, gas is not obstructed from entering the valve conduit 140 via the sump end 146 of the valve conduit 140. Operation of the solenoid valve 130 may control the amount of gas that is purged, such as based on electronic inputs from the electronic control module 18 that communicates with the solenoid valve 130, allowing the water and gas mixture to flow through the drainage opening 168, through the drainage conduit 160, and through the outlet 124 when the solenoid valve 130 is in the open state.

Because the solenoid valve 130 may be responsible for both draining liquid water and purging gas from the chamber 104, the solenoid valve 130 is adjusted from the closed state to the open state responsive to both control signals instructing the capture device 100 to drain liquid from the chamber 104 and control signals instructing the capture device 100 to purge gas from the chamber 104. In other words, operation of the solenoid valve 130 may be identical whether the system is requested to drain water or purge gas. Further, the solenoid valve 130 may be automatically adjusted from the closed state to the open state upon vehicle startup, to initiate drainage of residual water and purging of residual gas before further operation of the fuel cell system 12.

During operation of the fuel cell 14, water and gas exits the fuel cell 14 and enters the capture device 100 through the intake hose 116. Water and gas may separate within the chamber 104. When the solenoid valve 130 is in the closed state, the water is retained within the chamber 104 and settles in the sump 132, while the gas may be recirculated back to the fuel cell 14 via operation of the check valve 128. When the solenoid valve 130 is in the open state, both the water and an excess portion of the gas flow from the chamber 104 to the sump 132, where the water and gas enter the sump end 146 of the valve conduit 140 and travel through the valve conduit channel 142. The water and/or gas flow through the solenoid valve 130, into the drainage opening 168, through the drainage conduit 160, and through the outlet 124, where the water and/or gas may be discarded as waste through the exhaust 16. This cycle may continue during operation of the hydrogen fuel cell system 12.

When the hydrogen fuel cell system 12 is not being operated and residual water 134 remains in the sump 132, the residual water 134 may freeze when the ambient temperature at the capture device 100 is below the freezing temperature of water. Because the residual water is in the form of ice during these temperature conditions, the solid water may block the sump end 146 of the valve conduit 140, preventing gas from entering the valve conduit channel 142 at the sump end 146. To melt the frozen residual water 134, an electrically operable heater 172 may be disposed within the capture device 100, such as at or near the sump end 146. Operation of the heater 172 may be initiated when the vehicle 10 is started, however, the heater 172 may not immediately melt the frozen water.

To purge gas via operation of the solenoid valve 130 when the sump end 146 is blocked, the gas travels from the chamber 104 to the valve conduit 140 via the gas bypass hose 118. In other words, the gas bypass hose 118 maintains fluid communication between the chamber 104 and the valve conduit 140 even when the sump end 146 is blocked. When the solenoid valve 130 is adjusted to the open state, the gas travels through the gas bypass hose 118 from the first end 120 at the upper end region 106 of the chamber 104 to the second end 122, where the gas exits the gas bypass hose 118 via the gas conduit end 154. The gas travels through the gas conduit channel 152 to the valve conduit end 156 where the gas exits into the valve conduit 140 via the gas opening 158. Because the gas opening 158 is above the maximum water line 136, the gas opening 158 may be unobstructed by the frozen residual water 134 and the solenoid valve 130 can effectively purge the gas before the residual water 134 melts. The immediate purging of gas upon initial operation of the vehicle 10 and associated hydrogen fuel cell system 12 allows for proper and effective functionality of the vehicle 10 and hydrogen fuel cell system 12 even during conditions below the freezing temperature of water.

Once the heater 172 melts the frozen residual water 134, the sump end 146 of the valve conduit 140 may be unobstructed, allowing the purging of gas and the draining of water to be facilitated by the solenoid valve 130 via the sump end 146.

Thus, the capture device 100 incorporating one valve capable of draining water and purging gas during all operational conditions of the vehicle 10 provides improved packaging, reduced materials, reduced weight and more simplistic control.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A capture device, the capture device comprising:
a body defining a chamber configured to receive liquid and gas from a fuel cell system, the chamber comprising an upper end region and a lower end region:
an outlet disposed at the body and in fluid communication with the lower end region of the chamber:
a gas bypass hose including a first end at the body and in fluid communication with the upper end region of the chamber and a second end at the body and in fluid communication with the lower end region of the chamber; and
a solenoid valve disposed between the chamber and the outlet and operable between an open state permitting fluid communication between the chamber and the outlet to drain liquid and purge gas from the chamber and a closed state preventing fluid communication between the chamber and the outlet.

2. The capture device of claim 1, further comprising a sump at the lower end region of the chamber, the outlet and the second end of the gas bypass hose fluidly connected to the sump at respective positions above a maximum liquid line.

3. The capture device of claim 2, wherein the maximum liquid line is based on a volume of liquid collected at the sump when the fuel cell system is not being operated.

4. The capture device of claim 2, further comprising a valve conduit extending between the chamber and the outlet, the outlet and the second end of the gas bypass hose being fluidly connected to the valve conduit at respective positions above the maximum liquid line to permit fluid communication between the gas bypass hose and the outlet when the solenoid valve is in the open state.

5. The capture device of claim 1, further comprising a heater disposed at the outlet.

6. The capture device of claim 1, wherein the gas bypass hose maintains fluid communication between the upper end region of the chamber and the lower end region of the chamber.

7. The capture device of claim 1, wherein the solenoid valve operated in the open state and the closed state based on a control signal from a control module of an application equipped with the capture device.

8. The capture device of claim 7, wherein the solenoid valve is operated in the open state responsive to (i) the control signal instructing the capture device to drain liquid from the chamber and (ii) the control signal instructing the capture device to purge gas from the chamber.

9. The capture device of claim 7, wherein the solenoid valve is operated in the open state responsive to the control signal indicating startup of the application.

10. The capture device of claim 1, wherein the upper end region of the chamber is oriented above the lower end region of the chamber.

11. A fuel cell system, the fuel cell system comprising a capture device, the capture device comprising:
a body defining a chamber configured to receive liquid and gas from the fuel cell system, the chamber comprising an upper end region and a lower end region:
an outlet disposed at the body and in fluid communication with the lower end region of the chamber;
a gas bypass hose including a first end at the body and in fluid communication with the upper end region of the chamber and a second end at the body and in fluid communication with the lower end region of the chamber; and
a solenoid valve disposed between the chamber and the outlet and operable between an open state permitting fluid communication between the chamber and the outlet to drain liquid and purge gas from the chamber and a closed state preventing fluid communication between the chamber and the outlet.

12. The fuel cell system of claim 11, further comprising a sump at the lower end region of the chamber, the outlet and the second end of the gas bypass hose fluidly connected to the sump at respective positions above a maximum liquid line, the maximum liquid line based on a volume of liquid collected at the sump when the fuel cell system is not being operated.

13. The fuel cell system of claim 12, further comprising a valve conduit extending between the chamber and the outlet, the outlet and the second end of the gas bypass hose being fluidly connected to the valve conduit at respective positions above the maximum liquid line to permit fluid communication between the gas bypass hose and the outlet when the solenoid valve is in the open state.

14. The fuel cell system of claim 12, wherein the gas bypass hose maintains fluid communication between the upper end region of the chamber and the lower end region of the chamber.

15. The fuel cell system of claim 12, wherein the solenoid valve is operated in the open state and the closed state based on a control signal from a control module of an application equipped with the capture device, the solenoid valve operated in the open state responsive to (i) the control signal instructing the capture device to drain liquid from the chamber, (ii) the control signal instructing the capture device to purge gas from the chamber, and (iii) the control signal indicating startup of the application.

16. A vehicle, the vehicle comprising a fuel cell system, the fuel cell system comprising a capture device, the capture device comprising:
a body defining a chamber configured to receive liquid and gas from the fuel cell system, the chamber comprising an upper end region and a lower end region:
an outlet disposed at the body and in fluid communication with the lower end region of the chamber;
a gas bypass hose including a first end at the body and in fluid communication with the upper end region of the chamber and a second end at the body and in fluid communication with the lower end region of the chamber; and
a solenoid valve disposed between the chamber and the outlet and operable between an open state permitting fluid communication between the chamber and the outlet to drain liquid and purge gas from the chamber and a closed state preventing fluid communication between the chamber and the outlet.

17. The vehicle of claim 16, further comprising a sump at the lower end region of the chamber, the outlet and the second end of the gas bypass hose fluidly connected to the sump at respective positions above a maximum liquid line, the maximum liquid line based on a volume of liquid collected at the sump when the fuel cell system is not being operated.

18. The vehicle of claim 17, further comprising a valve conduit extending between the chamber and the outlet, the outlet and the second end of the gas bypass hose being fluidly connected to the valve conduit at respective positions above the maximum liquid line to permit fluid communication between the gas bypass hose and the outlet when the solenoid valve is in the open state.

19. The vehicle of claim 16, wherein the gas bypass hose maintains fluid communication between the upper end region of the chamber and the lower end region of the chamber.

20. The vehicle of claim 16, wherein the solenoid valve is operated in the open state and the closed state based on a control signal from a control module of the vehicle, the solenoid valve operated in the open state responsive to (i) the control signal instructing the capture device to drain liquid from the chamber, (ii) the control signal instructing the capture device to purge gas from the chamber, and (iii) the control signal indicating startup of the vehicle.
